(19) United States
(12) Patent Application Publication
(10) Pub. No.: US 2017/0069414 A1
(43) Pub. Date: Mar. 9, 2017

(54) SUPERCONDUCTING MAGNET APPARATUS

(71) Applicant: Samsung Electronics Co., Ltd., Gyeonggi-do (KR)

(72) Inventor: Kyu Wan HWANG, Gyeonggi-do (KR)

(21) Appl. No.: 15/245,354

(22) Filed: Aug. 24, 2016

(30) Foreign Application Priority Data
Sep. 9, 2015 (KR) 10-2015-0127401

(51) Int. Cl. H01F 6/04; F17C 3/08

(52) U.S. Cl. CPC H01F 6/04; F17C 3/085

(57) ABSTRACT

The present disclosure relates to a superconducting magnet apparatus including a cryogenic cooler and a cooler chamber accommodating the cooler. At least one protrusion is provided on one of the outer surface of the cryogenic cooler and the inner surface of the cooler chamber, and a holding groove is provided in the other one thereof. The protrusion is inserted in the holding groove, thereby stably maintaining a state in which the cryogenic cooler is installed in the cooler chamber through the holding groove and protrusion.

### CLAIM OF PRIORITY

This application claims priority to and the benefit under 35 U.S.C. §119 of Korean Patent Application No. 10-2015-0127401, filed on Sep. 9, 2015, the disclosure of which is incorporated herein by reference in its entirety.

### BACKGROUND

1. Technical Field

The present disclosure relates to a superconducting magnet apparatus including a cryogenic cooler capable of maintaining a cryogenic state of a superconducting magnet.

2. Discussion of Related Art

Generally, a superconducting magnet apparatus generates a high magnetic field using a superconducting magnet. One prominent application of a superconducting magnet apparatus is for use within a magnetic resonance imaging (MRI) apparatus.

In a superconducting magnet apparatus, a cryogenic container accommodates a refrigerant along with the superconducting magnet. A shielding container accommodates the cryogenic container and suppresses heat transfer from the outside to the inside. A vacuum container accommodates the shielding container and maintains the inside thereof in a vacuum state to block heat from being transferred due to convection. A cryogenic cooler maintains the cryogenic state of the superconducting magnet by cooling a refrigerant, and a cooler chamber accommodates the cryogenic cooler.

### SUMMARY

The present disclosure is directed to a superconducting magnet apparatus that may be capable of maintaining a designed thermal contact performance regardless of factors such as deformation due to vacuum pressure, deformation due to thermal contraction generated when being cooled down to an extremely low (cryogenic) temperature, vibration according to a long-term operation, and worker's skill at the time of repair or assembling, by more stably installing the cryogenic cooler in the cooler chamber.

According to an aspect of the present disclosure, there is provided a superconducting magnet apparatus including a cryogenic cooler, a cooler chamber configured to accommodate the cryogenic cooler, protrusions protruding from any one of an outer surface of the cryogenic cooler and an inner surface of the cooler chamber, and holding grooves provided in the other one of the outer surface of the cryogenic cooler and the inner surface of the cooler chamber to correspond to the protrusion and guide the cryogenic cooler to an interior of the cooler chamber.

The holding groove may include a guide channel extending in a coupling direction of the cryogenic cooler and a holding part extending from the guide channel in a circumferential direction to catch the protrusion.

The guide channel may have a width gradually reduced from an inlet side thereof in an entry direction of the cryogenic cooler.

The protrusions may include a pair of protrusions provided on opposite sides of any one of the outer surface of the cryogenic cooler and the inner surface of the cooler chamber, and the holding grooves may include a pair of holding grooves provided in regions on opposite sides of the other one of the outer surface of the cryogenic cooler and the inner surface of the cooler chamber.

A protrusion may be formed as a spiral protrusion, and a spiral holding groove may be formed to correspond to the spiral protrusion so that the spiral protrusion is screw coupled to the spiral holding groove according to the rotation of the cooler.

The cooler chamber may include a recondensing unit to which a refrigerant is transferred, the cryogenic cooler may include a heat exchanger integrally provided at the front end thereof and disposed in the recondensing unit, each protrusion may be provided at any one of an outer surface of the heat exchanger and an inner surface of the recondensing unit, and each holding groove may be provided in the other one of the outer surface of the heat exchanger and the inner surface of the recondensing unit.

The superconducting magnet apparatus may further include a recondensing chamber configured to be separated from a second accommodating part by a partition, and the front end of the cryogenic cooler may be in contact with a first surface of the partition.

The superconducting magnet apparatus may further include a heat exchanger disposed in the recondensing chamber and disposed on a second surface of the partition opposite the first surface.

The cryogenic cooler may include a central part and a front end extending from the central part, the cooler chamber may include a first accommodating part configured to accommodate the central part and the second accommodating part configured to accommodate the front end, each protrusion may be provided on any one of the outer surface of the central part and the inner surface of the first accommodating part, and the holding groove may be provided in the other one of the outer surface of the central part and the inner surface of the first accommodating part.

The cryogenic cooler may include a central part and a front end extending from the central part and operating at a lower temperature than the central part, the cooler chamber may include a first accommodating part configured to accommodate the central part and a second accommodating part configured to accommodate the front end, the protrusion may be provided on any one of an outer surface of the front end and an inner surface of the second accommodating part, and the holding groove may be provided in the other one of the outer surface of the front end and the inner surface of the second accommodating part.

According to another aspect of the present disclosure, there is provided a superconducting magnet apparatus including a cryogenic cooler, a cooler chamber configured to accommodate the cryogenic cooler, a heat exchanger integrally provided at the front end of the cryogenic cooler, a recondensing unit provided in the cooler chamber to accommodate the heat exchanger, a protrusion protruding from any one of an outer surface of the heat exchanger and an inner surface of the recondensing unit; and a holding groove provided in the other one of the outer surface of the heat exchanger and the inner surface of the recondensing unit. The protrusion fits within the holding groove so that the holding groove and the protrusion together guide transverse movement of the cryogenic cooler with respect to the cooler chamber.

According to still another aspect of the present disclosure, there is provided a superconducting magnet apparatus including a cryogenic cooler, a cooler chamber configured to accommodate the cryogenic cooler, a recondensing chamber separated from the cooler chamber with a partition, a protrusion protruding from any one of an outer surface of the cryogenic cooler and an inner surface of the cooler chamber, and a holding groove provided in the other one of the outer surface of the cryogenic cooler and the inner surface of the cooler chamber. The protrusion fits within the holding groove so that the holding groove and the protrusion together guide transverse movement of the cryogenic cooler with respect to the cooler chamber.

The front end of the cryogenic cooler may be brought into close contact with a first surface of the partition, and the superconducting magnet apparatus may further include a heat exchanger disposed in the recondensing chamber and disposed on a second surface of the partition opposite the first surface.

According to yet another aspect of the present disclosure, there is provided a superconducting magnet apparatus including a cryogenic cooler, a cooler chamber configured to accommodate the cryogenic cooler, protrusions protruding from any one of an outer surface of the cryogenic cooler and an inner surface of the cooler chamber, and holding projections protruding from the other one of the outer surface of the cryogenic cooler and the inner surface of the cooler chamber so that the protrusions are caught to be supported.

The holding projection may include a plurality of supporting projections disposed spaced apart in a circumferential direction, and a space between the holding projections is formed to be larger than the circumferential width of the protrusion.

The protrusion may be formed in a planar shape having a circumferential width.

The cryogenic cooler may include a first end part (“central part”) and a second end part (“front end”) extending from the first end part, the cooler chamber may include a first accommodating part configured to accommodate the first end part and a second accommodating part configured to accommodate the second end part, the protrusion may be provided on any one of an outer surface of the second end part and an inner surface of the second accommodating part, and the holding projection may be provided on the other one of the outer surface of the second end part and the inner surface of the second accommodating part.

### BRIEF DESCRIPTION OF THE DRAWINGS

The above and other aspects, features and advantages of the present disclosure will become more apparent to those of ordinary skill in the art in conjunction with the below detailed description of illustrative embodiments thereof with reference to the accompanying drawings, in which like reference numerals indicate like elements or features, in which:

FIG. 1 is a schematic view of a superconducting magnet apparatus applied with a cryogenic cooler according to an embodiment of the present disclosure;

FIG. 2 is a cross-sectional view showing an installation state of an example cryogenic cooler applied to a superconducting magnet apparatus according to an embodiment;

FIG. 3 is an exploded perspective view showing a state in which a heat exchanger of the cryogenic cooler is installed in a recondensing unit in the cryogenic cooler applied to the superconducting magnet apparatus according to an embodiment;

FIG. 4, FIG. 5 and FIG. 6 are each views showing a process of installing the cryogenic cooler in the superconducting magnet apparatus according to an embodiment;

FIG. 7 is an exploded perspective view showing an installation of a heat exchanger and a front end part of a cryogenic cooler in a superconducting magnet apparatus according to an alternative embodiment;

FIG. 8 is a cross-sectional view of an assembly of the elements of FIG. 7, showing a state in which the heat exchanger is installed in a recondensing unit in the superconducting magnet apparatus according to an alternative embodiment;

FIG. 9 is a cross-sectional view showing a state of installing a cryogenic cooler applied to a superconducting magnet apparatus according to a further embodiment;

FIG. 10 is a cross-sectional view showing a state in which the cryogenic cooler is installed in a second accommodating part in the superconducting magnet apparatus according to the further embodiment of FIG. 9;

FIG. 11 is an exploded perspective view showing a state in which a heat exchanger of a cryogenic cooler is installed in a recondensing unit in a superconducting magnet apparatus according to yet another embodiment; and

FIG. 12 is a perspective view showing a state in which the heat exchanger of the cryogenic cooler shown in FIG. 11 is installed in the recondensing unit in the superconducting magnet apparatus according to an embodiment.

### DETAILED DESCRIPTION

Hereinafter, superconducting magnet apparatuses according to various embodiments of the present disclosure will be described in detail with reference to the drawings.

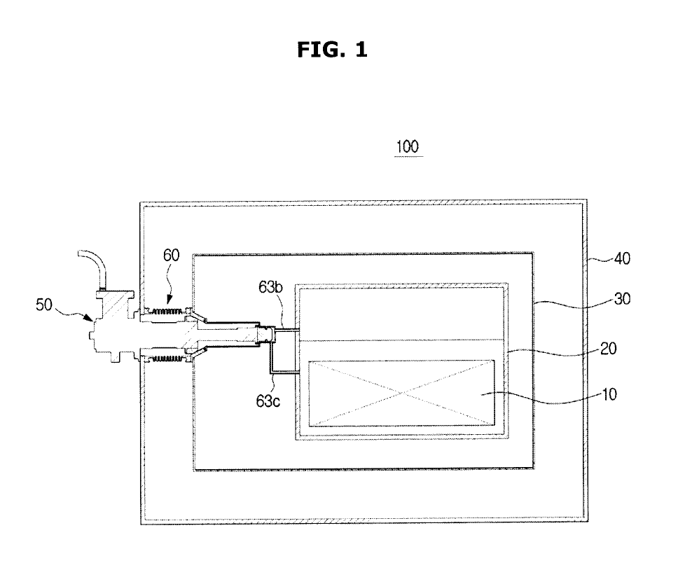

Referring to FIG. 1, a superconducting magnet apparatus 100 according to a first embodiment may include a superconducting magnet 10, a cryogenic container 20, a vacuum container 40 and a cryogenic cooler 50. Cryogenic container 20 may accommodate the superconducting magnet 10 and maintain the same at an extremely low (cryogenic) temperature. Shielding container 30 may thermally block the cryogenic container 20 from the exterior. Vacuum container 40 may seal the shielding container 30 using an evacuated space. Cryogenic cooler 50 may allow the cryogenic container 20 to be maintained at the cryogenic temperature. As one non-limiting application, superconducting magnetic apparatus 1 may form part of an MRI apparatus.

Superconducting magnet 10 may be formed with a superconducting coil and generate a high magnetic field at the cryogenic temperature.

Cryogenic container 20 may accommodate the superconducting magnet 10 and a refrigerant for cooling the superconducting magnet 10. Superconducting magnet 10 may be maintained submerged in a liquid refrigerant in the cryogenic container 20. A cryogenic refrigerant such as helium may be used as the refrigerant.

Shielding container 30 may suppress heat from being transferred from the outside to the inside thereof to thereby maintain the cryogenic container 20 accommodated therein at the cryogenic temperature.

Vacuum container 40 may accommodate the shielding container 30 therein. The inside of vacuum container 40 may be maintained in a high vacuum state to prevent heat from being transferred from outside to inside thereof by convection.

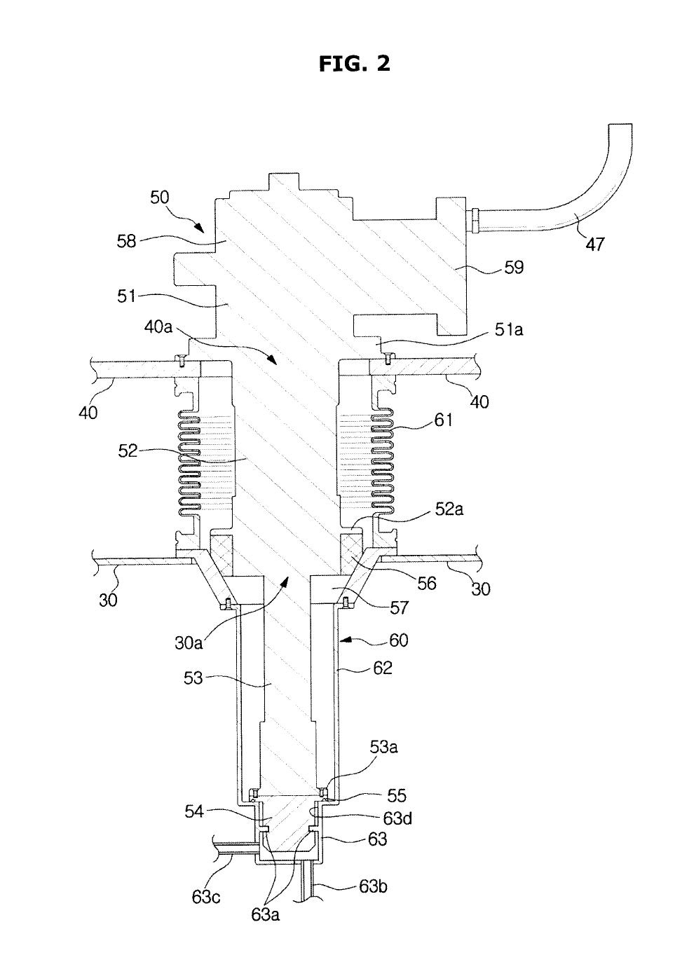

The cryogenic cooler 50, as shown in the example of FIG. 2, may be formed as a two-stage cryogenic cooler including an input end 51, a central part 52 extending from the input end 51 and operating in a first temperature range, and a second end 53 extending from the central part 52 and operating in a second temperature range lower than the first temperature range. (The second end 53 is also be referred to interchangeably herein as a front end of the cryogenic cooler.) As illustrated, the central part 52 and the second end 53 may each have an elongated tubular configuration, and coaxially aligned with one another along a main axis of the cryogenic cooler 50. Input end 51 may be in the form of a first tubular section 58 coaxially aligned with the central part 52, and a second tubular section 59 approximately orthogonal to the first tubular section 58 and coupled to an inlet hose 47. In an embodiment, the central part 52 may operate in the temperature range of 30 to 60 K, and the second end 53 may operate at a temperature of about 4 K.

As seen in FIG. 1, input end 51 is disposed outside the vacuum container 40, whereas the central part 52 is disposed between the vacuum container 40 and the shielding container 30. Also, the second end 53 is disposed between the shielding container 30 and the cryogenic container.

Superconducting magnet apparatus 1 may further include a cooler chamber 60 so that the cryogenic cooler 50 may be installed with parts thereof surrounded by cooler chamber 60, and with parts penetrating the shielding container 30 and the vacuum container 40.

The vacuum container 40 and the shielding container 30 may respectively include a first installation hole 40a and a second installation hole 30a to install the cryogenic cooler 50. Also, the cooler chamber 60 may include a first accommodating part 61 which forms a space for connecting the first installation hole 40a with the second installation hole 30a and accommodates the central part 52 therein. A second accommodating part 62 of cooler chamber 60 may extend from the first accommodating part 61 and form a space for accommodating the front end (i.e. second end) 53 of cryogenic cooler 50. A connecting part of cooler chamber 60 may connect the first accommodating part 61 with the second accommodating part 62 and may have a hollow wedge shape having a diameter gradually reduced from the first accommodating part 61 toward the second accommodating part 62. In this embodiment, a central portion of the first accommodating part 61 may have a bellows tube shape to correspond to the thermal contraction generated when cooled down to the cryogenic temperature.

Cooler chamber 60 may further include a recondensing unit 63 connected with the second accommodating part 62 and receiving a vaporized refrigerant from the cryogenic container 20 to recondense the refrigerant to liquid. Recondensing unit 63 may be connected with a suctioning passage 63b into which the vaporized refrigerant is suctioned. A discharging passage 63c may be connected and perform heat exchange with a heat exchanger 54 and guide the liquefied refrigerant back to the cryogenic container 20.

Cryogenic cooler 50 may further include a flange part 51a extending radially outward from the input end 51 to form an approximately circular shape and fixed to a part adjacent to the first installation hole 40a of the vacuum container 40 through a bolt, etc. A first supporting projection 52a may extend radially outward from the central part 52 to form an approximately circular shape and may be supported on a part 57 adjacent to the second installation hole 30a of the shielding container 30. A second supporting projection 53a may extend radially outward from the second end 53 to form an approximately circular shape and may be supported on a part adjacent to a stepped part 63d to be described below.

Meanwhile, the cryogenic cooler 50 may be integrally connected with the heat exchanger 54 at a front portion of the second end 53. The heat exchanger 54 increases a heat exchange area with the refrigerant passing through the recondensing unit 63 to more easily absorb heat from the refrigerant. The heat exchanger 54 is disposed in the recondensing unit 63 while the cryogenic cooler 50 is installed in the cooler chamber 60. The recondensing unit 63 is formed to have a diameter relatively smaller than the cooler chamber 60 and includes the stepped part 63d between the recondensing unit 63 and the cooler chamber 60.

As mentioned above, the second supporting projection 53a may be supported on the stepped part 63d, and a sealing member 55 is disposed between the second supporting projection 53a and a front end surface of the second accommodating part 62 on which the second supporting projection 53a is supported. Also, a sealing member 56 is disposed between the first supporting projection 52a and the part adjacent to the second installation hole 30a of the shielding container 30. In this example, the sealing members 55 and 56 have circular shapes similar to the second supporting projection 53a and are made of soft metal to be suitable for the extremely low temperature.

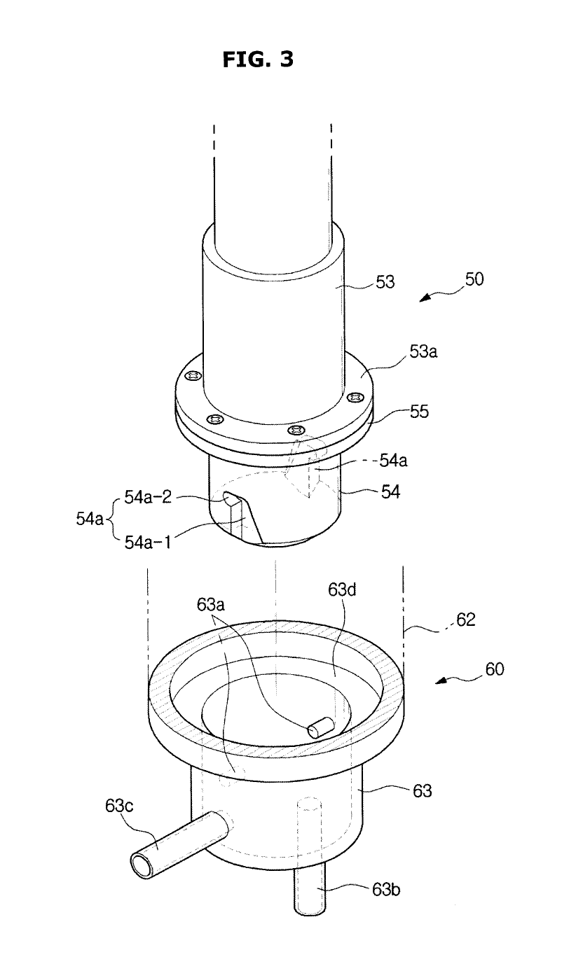

Referring now to FIG. 3, cooler chamber 60 may include protrusions 63a protruding from the inner surface of the cooler chamber 60 so that the cryogenic cooler 50 installed in the cooler chamber 60 is stably installed in the cooler chamber 60. Cryogenic cooler 50 may include holding grooves 54a formed in the outer cylindrical surface of heat exchanger 54 to correspond to the protrusions 63a so that the protrusions 63a are inserted thereinto to be caught.

The protrusion 63a may be formed to have a circular cross-section to easily enter the holding groove 54a. Holding groove 54a may include a guide channel 54a-1 extending in an insertion direction of the cryogenic cooler 50 and a holding part 54a-2 extending from guide channel 54a-1 in a circumferential direction of heat exchanger 54's cylindrical shape to catch the protrusion 63a. An inlet side of the guide channel 54a-1 may have a width larger than a diameter of the protrusion 63a and the width is gradually reduced from the inlet side toward the holding part 54a-2. Therefore, the protrusion 63a easily enters the guide channel 54a-1.

In an example, a pair of protrusions 63a are provided on the opposite sides of the inner surface of the recondensing unit 63, and the holding grooves 54a include a pair of holding grooves 54a provided in the opposite sides of the outer surface of the heat exchanger 54.

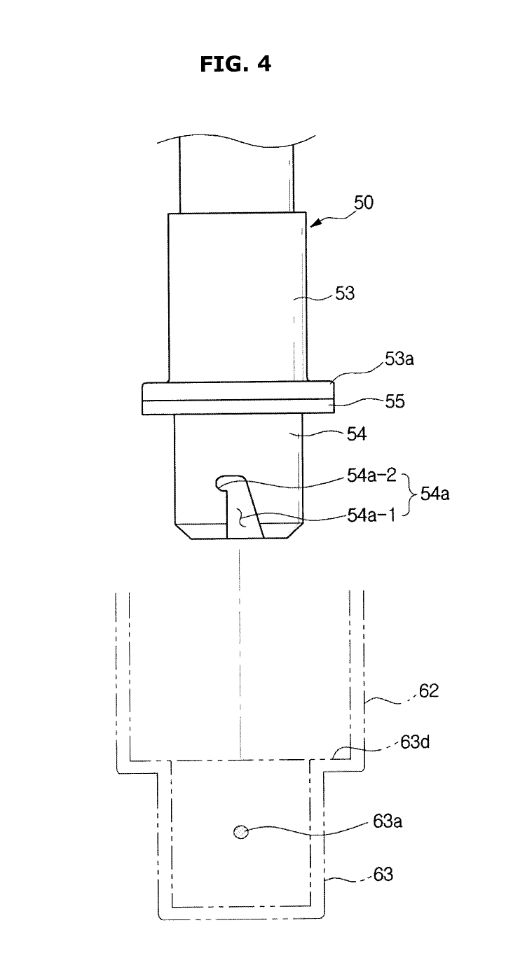

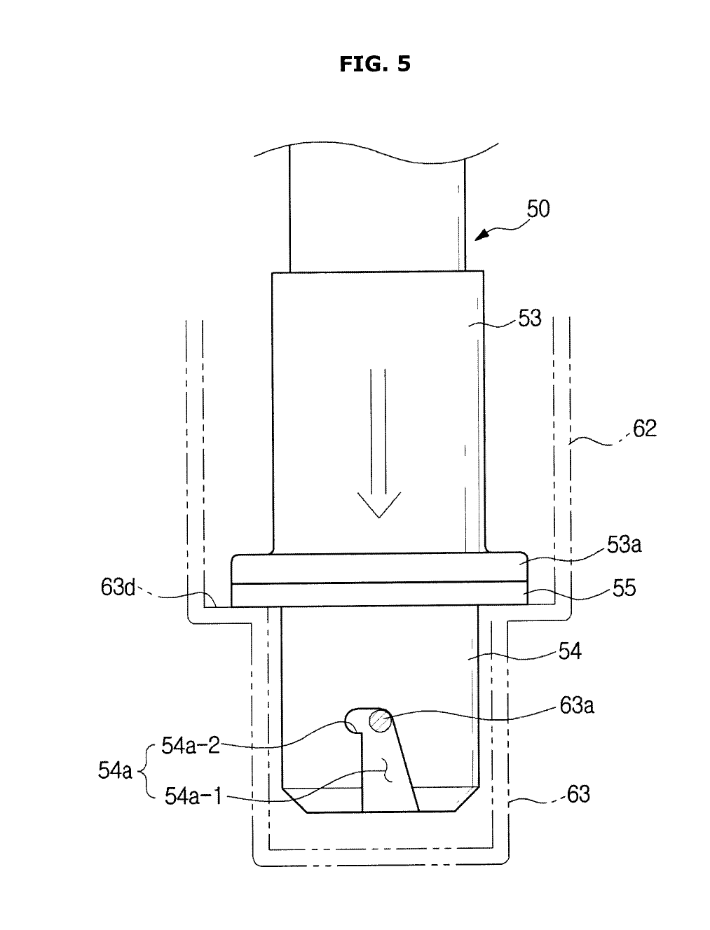

Therefore, as shown in FIG. 4, when the cryogenic cooler 50 is inserted into the cooler chamber 60, the protrusion 63a enters the guide channel 54a-1 of the holding groove 54a. As shown in FIG. 5, when the protrusion 63a is completely inserted into the guide channel (or part) 54a-1 and the cryogenic cooler 50 is rotated, as shown in FIG. 6, the protrusion 63a is inserted into the holding part 54a-2 of the holding groove 54a to be supported. That is, the heat exchanger 54 provided at the front end side of the cryogenic cooler 50 is supported on the recondensing unit 63 of the cooler chamber 60 through the protrusion 63a.

Considering fixing forces applied to various portions of cryogenic cooler 50, since cryogenic cooler 50 is fixed to the vacuum container 40 through the flange part 51a, the closer to the input end 51 a given portion is, the larger is the fixing force applied to that portion. Therefore, only a relatively small force is applied between the second supporting projection 53a spaced apart from the fixed flange part 51a and the front end surface of the second accommodating part 62.

However, as described above, when the heat exchanger 54 positioned at the front end of the cryogenic cooler 50 is supported on an inner surface of the recondensing unit 63 of the cooler chamber 60 through the protrusion 63a and the holding groove 54a, a pressure applied between the second supporting projection 53a and the front end surface of the second accommodating part 62 may be increased, and thus sealing between the second supporting projection 53a and the front end surface of the second accommodating part 62 may be stably maintained.

Since the cooler chamber 60 in which the cryogenic cooler 50 is installed, as described above, is installed to pass through the vacuum container 40, a deformation may be inevitably generated by vacuum pressure applied to the vacuum container 40, and thermal contraction may be generated in the cryogenic cooler 50 and the cooler chamber 60 when cooling is performed by the cryogenic cooler 50.

However, when the front end of the cryogenic cooler 50 is supported on the inner surface of the cooler chamber 60 through the protrusion 63a and the holding groove 54a, although the cooler chamber 60 and/or the cryogenic cooler 50 are deformed by the vacuum pressure and the thermal contraction, a state in which the front end side of the cryogenic cooler 50 is installed in the cooler chamber 60 may be stably maintained. Also, the structure allows for the installation of the cryogenic cooler 50 to be facilitated regardless of the skill of a worker when assembling or repair is performed.

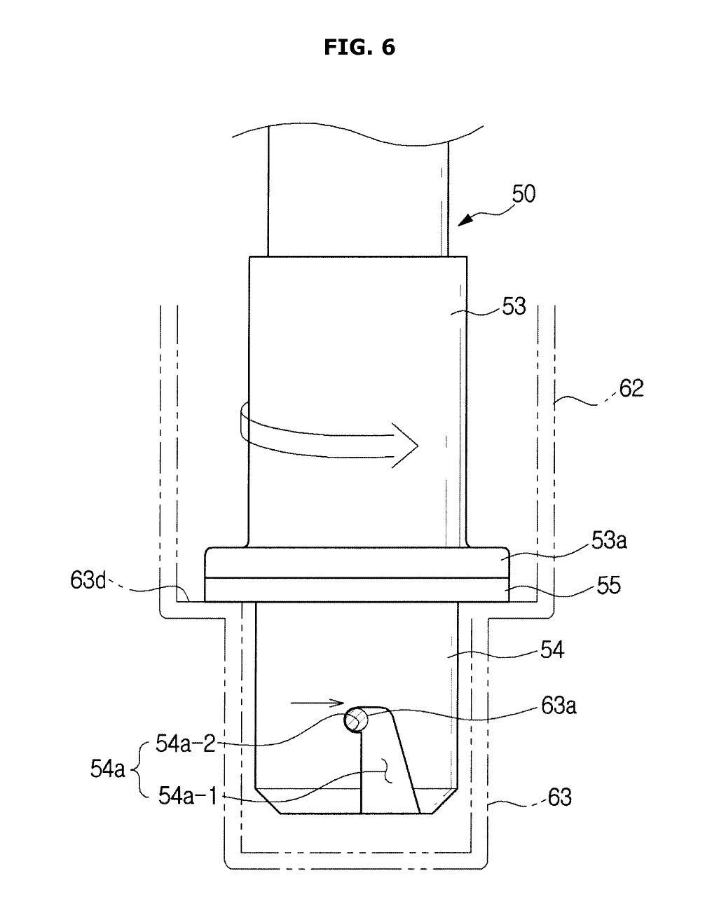

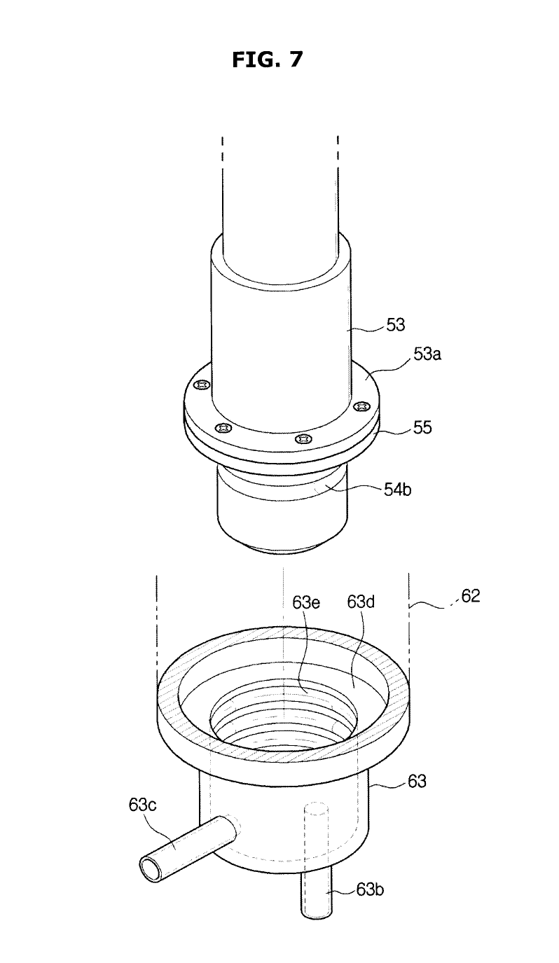

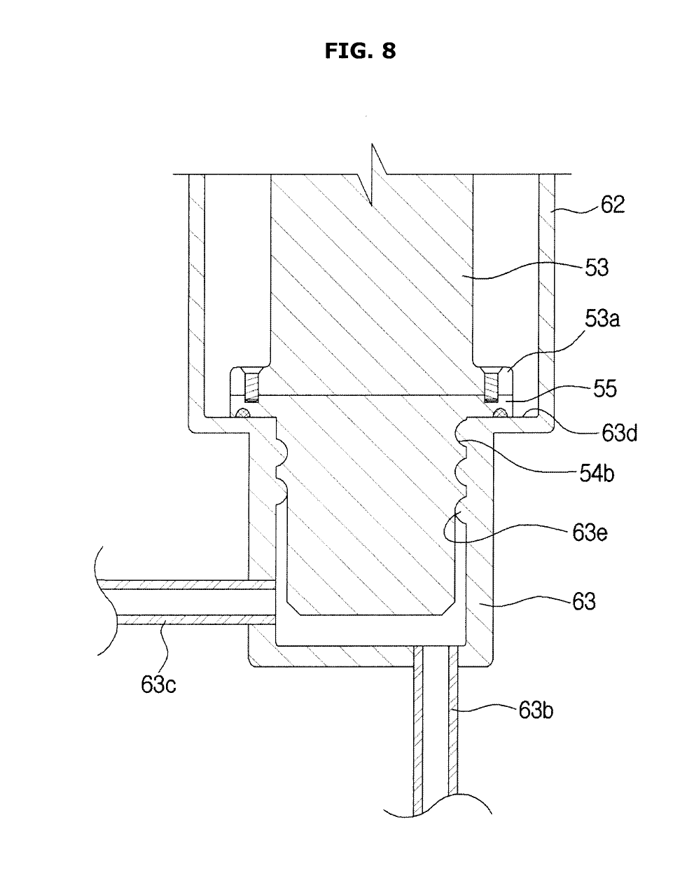

The above-described embodiment utilizes protrusion 63a with circular cross-section and holding groove 54a having holding part 54a-2 extending in a circumferential direction. However, alternative securing mechanisms are contemplated, such as those illustrated in FIGS. 7 and 8.

FIG. 7 is an exploded perspective view showing an installation of a heat exchanger and a front end of a cryogenic cooler in a superconducting magnet apparatus according to an alternative embodiment. FIG. 8 is a cross-sectional view of the elements of FIG. 7, showing a state in which the heat exchanger is installed in a recondensing unit in the superconducting magnet apparatus. In this embodiment, which includes alternative configurations of the cooler chamber 60 and cryogenic cooler 50, a protrusion 63e of cooler chamber 60 is formed spirally protruding. A holding groove 54b of cryogenic cooler 50 is formed concavely in a spiral shape, so that the heat exchanger 54 may be screw coupled with the recondensing unit 63 and thereby stably secure the far end of the cryogenic cooler.

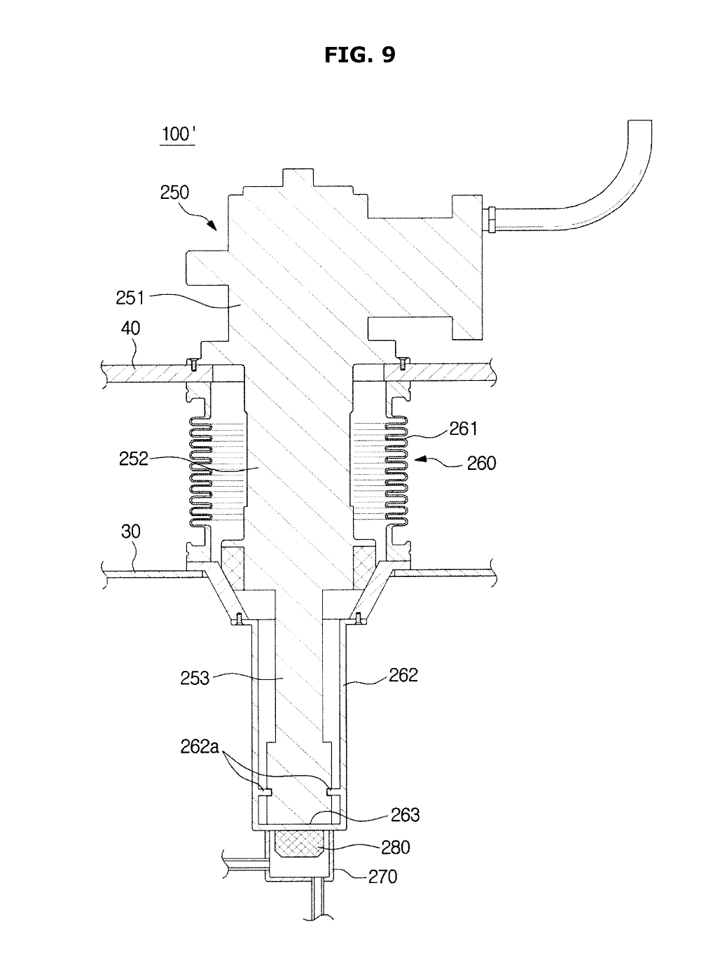

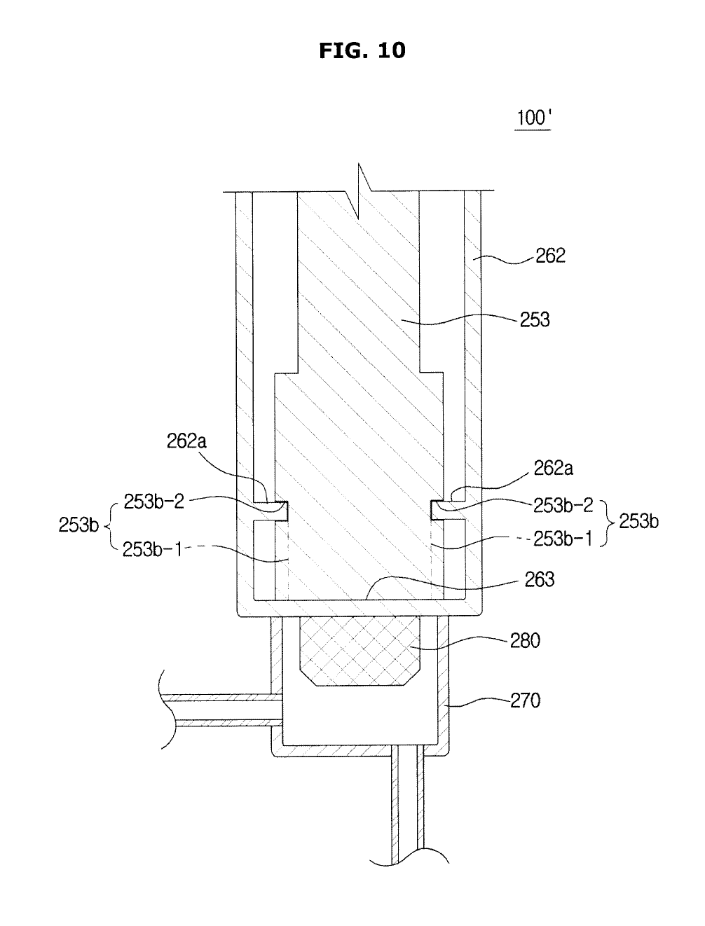

FIG. 9 is a cross-sectional view showing an installed state of a cryogenic cooler within a superconducting magnet apparatus according to still another embodiment of the present disclosure. FIG. 10 is a partial view of the apparatus of FIG. 9, showing a state in which the cryogenic cooler is installed in a second accommodating part of a cooler chamber of the superconducting magnet apparatus. In this embodiment, a superconducting magnet apparatus 100′ includes a cryogenic cooler 250, a cooler chamber 260 in which the cryogenic cooler 250 is installed, a recondensing chamber 270 separated from the cooler chamber 260 by a partition 263, and a heat exchanger 280 disposed in the recondensing chamber 270. (Superconducting magnet apparatus 100′ may also include the other elements shown in FIG. 1, the description thereof omitted here for brevity.)

The cryogenic cooler 250 includes an input end 251, a central part 252, and a second end 253. A front surface of the second end 253 is supported on a first surface of the partition 263 to absorb heat from the refrigerant passing through the recondensing chamber 270 through the partition 263. The heat exchanger 280 is disposed in the recondensing chamber 270, against a second surface of the partition 263 opposite the first surface.

The cooler chamber 260 includes a first accommodating part 261 accommodating the central part 252 and a second accommodating part 262 accommodating the second end 253.

The second accommodating part 262 includes a protrusion 262a protruding from the inner surface thereof so that the second end 253 is stably installed in the second accommodating part 262, and the second end 253 includes a holding groove 253b corresponding to the protrusion 262a. The holding groove 253b includes a vertically oriented guide channel 253b-1 (oriented along the direction of the main axis of cryogenic cooler 250) and a holding part 253b-2 extending from the guide channel 253b-1 in a circumferential direction similar to the above embodiment of FIG. 4. The structure thereby guides and supports the protrusion 262a following a slight rotation of the cryogenic cooler 250 after full insertion into the cooler chamber 260.

Therefore, since the second end 253 of the cryogenic cooler 250 is supported in the second accommodating part 262 with the protrusion 262a and the holding groove 253b, a state in which the cryogenic cooler 250 is installed in the cooler chamber 260 may be stably maintained. Particularly, although the cryogenic cooler 250 and/or the cooler chamber 260 may become deformed due to vacuum pressure or thermal contraction, the front portion of the second end 253 is stably maintained in contact with the first surface of the partition 263, thereby obtaining the designed thermal contact performance as designed. Also, the designed thermal contact performance can be obtained as designed regardless of the skill of a worker when repair or assembly is performed.

In the above example, the protrusion 262a protrudes from an inner surface of the second accommodating part 262, and the holding groove 253b is provided in an outer surface of the second end 253, but alternative configurations are contemplated. For instance, the protrusion may protrude from the inner surface of the first accommodating part, and the holding groove may be provided in the outer surface of the central part 252.

Also, the protrusions may alternatively protrude from inner surfaces of the first accommodating part 261 and the second accommodating part 262, respectively, while the holding grooves are provided on the outer surface of the central part 252 and the outer surface of the second end 253, respectively.

Further, while in the above examples, the protrusions are provided on the inner surface of the cooler chamber 260 while the holding groove is provided in the outer surface of the cryogenic cooler 250, other variations are possible. Conversely, one or more protrusions may be provided on the outer surface of the cryogenic cooler 250, and the holding groove may be provided in the inner surface of the cooler chamber 260.

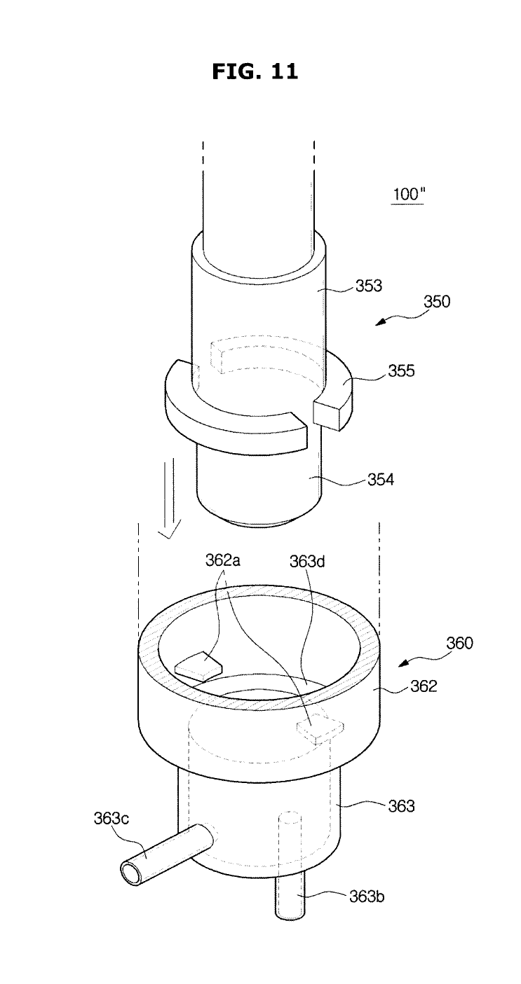

As described above, at least one protrusion is provided on one of the outer surface of the cryogenic cooler 50 or 250 and the inner surface of the cooler chamber 60 or 260 while the holding groove is provided on the other opposing surface, but still other alternatives are available. As shown in FIG. 11 which illustrates another embodiment superconducting magnet apparatus 100″ of the present disclosure, protrusions 362a protruding from the inner surface of the cooler chamber 360 in a planar shape may be formed, and holding projections 355 to be caught by the protrusions 362a may be formed on the outer surface of the cryogenic cooler 350 to be supported. (Superconducting magnet apparatus 100″ may also include the other elements shown in FIG. 1, the description thereof omitted here for brevity.)

In superconducting magnet apparatus 100″, the protrusions 362a protrude from both sides of the inner surface of a second accommodating part 362 of the cooler chamber 360 and are formed in a planar shape having a circumferential width, thereby being supported on the holding projections 355 through a plane.

The holding projections 355 are provided on the outer circumferential surface of a second end 353 of the cryogenic cooler 350 in a circumferential direction. In this embodiment, the two holding projections 355 are formed to be separated in a circumferential direction, and a space between the two holding projections 355 is formed to be larger than a circumferential width of the protrusion 362a, and thus the protrusion 362a may pass through a space between the two holding projections 355.

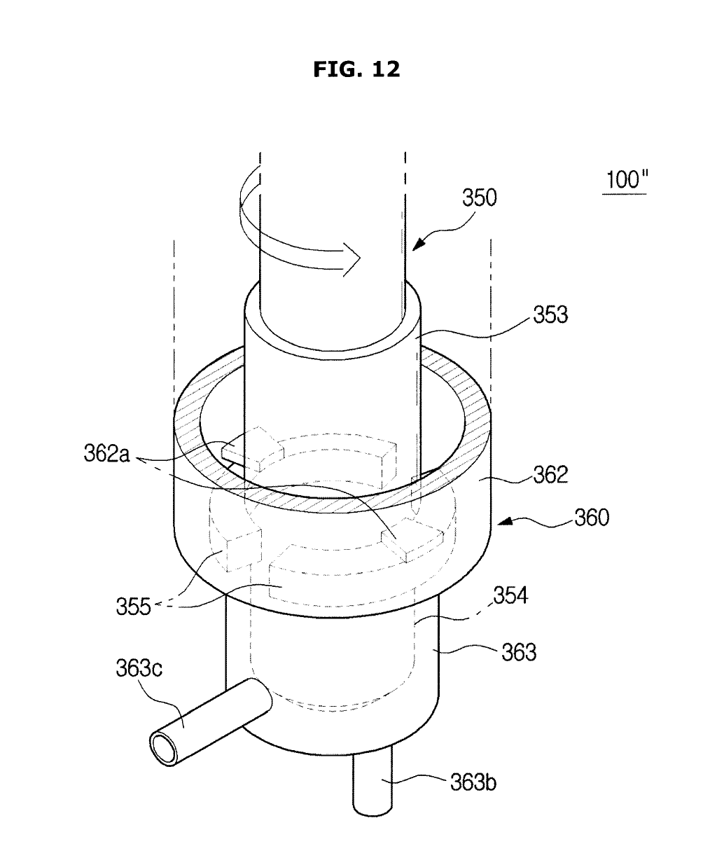

Therefore, when the cryogenic cooler 350 is installed in the cooler chamber 360 while the protrusion 362a is positioned to correspond to a space between the holding projections 355, the protrusion 362a passes through a space between the holding projections 355. In this case, when the cryogenic cooler 350 is again rotated at an angle of 90° in a circumferential direction, as shown in FIG. 12 the protrusions 362a are caught by the holding projections 355 to be supported, and thus the front end of the cryogenic cooler 350 is supported by the inner surface of the cooler chamber 360.

In the above example, the protrusions 362a are formed in a planar shape, but in alternative designs the protrusions may have various other shapes, e.g., a rod-like shape, etc. As illustrated in FIGS. 11 and 12, superconducting magnet apparatus 100″ may also include a heat exchanger 354 (part of cryogenic cooler 350), and a recondensing unit 363 analogous to recondensing unit 63, with suctioning passage 363b, discharging passage 363c and stepped part 363d.

In the above example, two protrusions 362a and two holding projections 355 are provided, but in other cases there may be three or more protrusions and three or more projections. However, even in this case, a space between the holding projections should be larger than the circumferential width of a protrusion passing between the holding projections so that each protrusion passes through a corresponding space.

In alternative embodiments to those illustrated and described above, instead of providing two or more protrusions and two or more holding grooves corresponding to the protrusions, just a single holding groove and a single protrusion may be employed to guide installation of the cryogenic cooler in the interior of the cooler chamber and secure the front (second) end of the cooler.

As described above, according to one aspect of the present disclosure, in the superconducting magnet apparatus applied with the cryogenic cooler, the front end side of the cryogenic cooler accommodated in the cooler chamber is supported by the cooler chamber through at least one protrusion and at least one holding groove, and thus the cryogenic cooler can be more stably installed in the cooler chamber.

Moreover, according to certain aspects, although the cryogenic cooler and/or the cooler chamber may be deformed by vacuum pressure and/or thermal contraction, a state in which the front end side of the cryogenic cooler is supported on a partition can be stably maintained, and thus a desirable thermal contact performance can be obtained as designed.

The present disclosure is not limited to the above described embodiments, but those skilled in the art will appreciate that various modifications and variations are possible without departing from the spirit of the invention as disclosed in the accompanying claims. Therefore, these variations or modifications should also be understood to fall within the scope of the appended claims.

What is claimed is:

1. A superconducting magnet apparatus comprising:
a cryogenic cooler;
a cooler chamber configured to accommodate the cryogenic cooler;
plural protrusions protruding from any one of an outer surface of the cryogenic cooler and an inner surface of the cooler chamber; and
plural holding grooves provided in the other one of the outer surface of the cryogenic cooler and the inner surface of the cooler chamber to correspond to the protrusions and configured to guide the cryogenic cooler into an interior of the cooler chamber.

2. The superconducting magnet apparatus of claim 1, wherein each of the holding grooves includes a guide channel extending in a main axial direction of the cryogenic cooler and a holding part extending from the guide channel in a circumferential direction to catch one of the protrusions.

3. The superconducting magnet apparatus of claim 2, wherein the guide channel has a width gradually reduced from an inlet side thereof in an entry direction of the cryogenic cooler.

4. The superconducting magnet apparatus of claim 1, wherein:
the protrusions include a pair of protrusions provided on opposite sides of any one of the outer surface of the cryogenic cooler and the inner surface of the cooler chamber; and
the holding grooves include a pair of holding grooves provided in regions on opposite sides of the other one of the outer surface of the cryogenic cooler and the inner surface of the cooler chamber.

5. The superconducting magnet apparatus of claim 1, wherein the protrusions comprise protrusion portions of a spiral protrusion, and the holding grooves are portions of a spiral groove to correspond to the spiral protrusion so that the spiral protrusion is screw coupled to the spiral groove according to a rotation of the cryogenic cooler.

6. The superconducting magnet apparatus of claim 1, wherein:
the cooler chamber includes a recondensing unit to which a refrigerant is transferred;
the cryogenic cooler includes a heat exchanger integrally provided at a front end thereof and disposed at the recondensing unit;
the protrusions are provided at any one of an outer surface of the heat exchanger and an inner surface of the recondensing unit; and
the holding grooves are provided in the other one of the outer surface of the heat exchanger and the inner surface of the recondensing unit.

7. The superconducting magnet apparatus of claim 1, further comprising a recondensing chamber configured to be separated from a second accommodating part of the cooler chamber by a partition,
wherein a front end of the cryogenic cooler is in contact with a first surface of the partition.

8. The superconducting magnet apparatus of claim 7, further comprising a heat exchanger disposed in the recondensing chamber against a second surface of the partition opposite the first surface.

9. The superconducting magnet apparatus of claim 7, wherein:
the cryogenic cooler includes a central part and a front end extending from the central part;
the cooler chamber includes a first accommodating part configured to accommodate the central part and the second accommodating part which is configured to accommodate the front end;
the protrusions are provided on any one of an outer surface of the first end part and an inner surface of the first accommodating part; and
the holding grooves are provided in the other one of the outer surface of the first end part and the inner surface of the first accommodating part.

10. The superconducting magnet apparatus of claim 7, wherein:
the cryogenic cooler includes a central part and a front end extending from the central part and operating at a lower temperature than the central part;
the cooler chamber includes a first accommodating part configured to accommodate the central part and the second accommodating part configured to accommodate the front end;
the protrusions are provided on any one of an outer surface of the front end and an inner surface of the second accommodating part; and
the holding grooves are provided in the other one of the outer surface of the front end and the inner surface of the second accommodating part.

11. A superconducting magnet apparatus comprising:
a cryogenic cooler;
a cooler chamber configured to accommodate the cryogenic cooler;
a recondensing chamber separated from the cooler chamber by a partition;
a protrusion protruding from any one of an outer surface of the cryogenic cooler and an inner surface of the cooler chamber; and
a holding groove provided in the other one of the outer surface of the cryogenic cooler and the inner surface of the cooler chamber, the protrusion fitting within the holding groove so that the holding groove and the protrusion together guide transverse movement of the cryogenic cooler with respect to the cooler chamber.

12. The superconducting magnet apparatus of claim 11, further comprising a heat exchanger disposed in the recondensing chamber against a second surface of the partition opposite a first surface of the partition, wherein a front end of the cryogenic cooler is brought into close contact with the first surface.

13. The superconducting magnet apparatus of claim 11, wherein:
the cryogenic cooler includes a central part and a front end extending from the central part;
the cooler chamber includes a first accommodating part configured to accommodate the central part and a second accommodating part configured to accommodate the front end;
the protrusion is provided on any one of an outer surface of the central part and an inner surface of the first accommodating part; and
the holding groove is provided in the other one of the outer surface of the central part and the inner surface of the first accommodating part.

14. The superconducting magnet apparatus of claim 11, wherein:
the cryogenic cooler includes a central part and a front end extending from the central part;
the cooler chamber includes a first accommodating part configured to accommodate the central part and a second accommodating part configured to accommodate the front end;
the protrusion is provided on any one of an outer surface of the front end and an inner surface of the second accommodating part; and
the holding groove is provided in the other one of the outer surface of the front end and the inner surface of the second accommodating part.

15. The superconducting magnet apparatus of claim 11, wherein the holding groove includes a guide channel extending in an insertion direction of the cryogenic cooler and a holding part extending from the guide channel in a circumferential direction to catch the protrusion.

16. A superconducting magnet apparatus comprising:
a cryogenic cooler;
a cooler chamber configured to accommodate the cryogenic cooler;
plural protrusions protruding from any one of an outer surface of the cryogenic cooler and an inner surface of the cooler chamber; and
plural holding projections protruding from the other one of the outer surface of the cryogenic cooler and the inner surface of the cooler chamber so that the protrusions are caught to be supported.

17. The superconducting magnet apparatus of claim 16, wherein:
the holding projections include a plurality of supporting projections disposed spaced apart in a circumferential direction; and
a space between the holding projections is formed to be larger than a circumferential width of a protrusion that passes therethrough during installation of the cryogenic cooler within the cooler chamber.

18. The superconducting magnet apparatus of claim 16, wherein the protrusion is formed in a planar shape with a circumferential width.

19. The superconducting magnet apparatus of claim 16, wherein:
the cryogenic cooler includes a central part and a front end extending from the first end part;
the cooler chamber includes a first accommodating part configured to accommodate the central part and a second accommodating part configured to accommodate the front end;
the protrusion is provided on any one of an outer surface of the front end and an inner surface of the second accommodating part; and
the holding projection is provided on the other one of the outer surface of the front end and the inner surface of the second accommodating part.
